(19) United States
(12) Patent Application Publication
(10) Pub. No.: US 2008/0136169 A1
(43) Pub. Date: Jun. 12, 2008

(54) Pipeline field joint coating for wet insulation with improved adhesion

(75) Inventor: Joseph C. Duncan, Katy, TX (US)

Correspondence Address: BRACEWELL & GIULIANI LLP, P.O. BOX 61389, HOUSTON, TX, 77208-1389, US

(73) Assignee: Offshore Joint Services, Inc.

(21) Appl. No.: 11/906,233

(22) Filed: Oct. 1, 2007

Related U.S. Application Data
(60) Provisional application No. 60/848,133, filed on Sep. 29, 2006.

(51) Int. Cl. F16L 55/00

(52) U.S. Cl. 285/41

(57) ABSTRACT

Bond strength is improved between a polyurethane joint infill material and the dissimilar polymer materials of the parent coating at a pipeline field joint in a wet insulation coating for a pipeline. Heat is introduced in addition to the flame or corona heating used in normal bonding, and as a result, the bond strength is improved. The injected liquid polyurethane of the infill meets the heat treated surface and fully wets the treated surface out prior to the surface losing the added heat.

### REFERENCE TO RELATED APPLICATIONS

This application claims the benefit of U.S. Provisional Patent Application Ser. No. 60/848,133 which was filed Sep. 29, 2006.

### BACKGROUND OF THE INVENTION

1. Field of the Invention

The present invention relates to field joint coating and infill of the uncoated area of welded pipelines/flowlines for subsequent placement, such as by being laid in bodies of water, entrenched, and buried or the like. 2. Description of the Related Art

As offshore oil and gas recovery goes into sub sea formations in deeper bodies of water, wells in these formations are producing higher temperature hydrocarbon products at much higher pressures. The wells in deeper bodies of water have usually been located further out from host processing facilities and the subsequent connecting flowlines and pipelines between the wells and the processing facilities have become longer. The deeper water depths and longer connecting pipelines and flowlines have meant that keeping the fluids flowing and preventing adverse conditions have become more important. Example adverse conditions to be avoided are wax deposits building up and hydrate formation within the line. In an attempt to alleviate these problems, so-called wet insulation systems on the exterior of the pipeline have been developed. Wet insulation is on the outside of the pipeline and thus exposed to the water and hydrostatic pressure, as against pipe-in-pipe, or “dry” insulation.

These wet insulations are generally based around solid syntactic or foamed polymeric materials such as polypropylene, polyethylene or polyurethane, although other materials may have also been embodied, such as nylon, PTFE, epoxies and other thermoplastic or thermosetting materials.

As with pipelines in shallower water depths, the pipes are generally supplied in 12 meter coated lengths and the exposed metal ends of the pipe extending beyond the coating are welded together, forming the joined lengths into a continuous line. Each welded joint is commonly known as the field joint area. More recently, this welding operation may have taken place before the factory coating was applied turning them into double joints and, thus eliminating one field joint area. The pipe lengths for such pipelines are usually coated along their lengths except for the exposed metal ends, with some fluid impermeable polymer or insulation as a protective coating, often known as the parent coating. To ensure that the welded area of pipe is adequately protected against corrosion and where insulation is necessary the area does not act as a cold spot in the line, the field joint must act in a similar fashion to that of the pipeline coating.

Typical offshore industry pipe coatings proposed for anticorrosion control have varied from coal tar enamels, bitumen, powdered coatings such as fusion bonded epoxy (FBE) to what are known as three layer polymer systems. Each of these systems is compatible with cathodic protection (CP) systems and has used anodes as a back-up for corrosion control in case of coating or field joint damage or breakdown. Where anodes can be used, it has meant that little attention has been paid to the field joint coating. The reason for this has been that since even if the anticorrosion coatings broke down, there would usually be sufficient protection given by the anodes so that no corrosion would occur. However, in the case of thick wet insulation systems the use of anodes as a secondary anticorrosion system can be impractical. The very thick insulation can shield the anode from working efficiently. There are therefore competing design considerations, a need for more secure anticorrosion protection in the field joint area and a need for a thicker thermal barrier field joint.

To achieve more secure anticorrosion and provide a thermal barrier with an integrity like that of the pipeline coating, with a thermosetting polyurethane wet insulation, the field joint has tended to be a base fusion bonded epoxy or a primer layer followed by a coating of a fast gelling two part polyurethane system, similar or identical to the parent coating. This allowed for rapid field jointing due to the rapid setting of the material, to match the welding rate and lay speed of the pipe laying vessel. By proper preparation of the parent coating a fully compatible field joint can usually be achieved, one which is capable of being laid immediately after coating as well as offering end to end coating integrity.

However, in the case of thermoplastic insulation, the design of field joint is more complicated. Fast setting polyurethane has been utilized. However, the use of dissimilar materials has proven problematic. The polypropylene surface had to be specially treated to achieve a bond between it and the thermosetting polyurethane. The dissimilar process was such that the quality of bond is questionable and may lead to the breakdown of the interface bond, allowing water ingression down the interface chamfer to the pipe wall surface. This in turn would subject the polyurethane to hot water at the pipe interface which in turn could then attack the polyurethane and cause subsequent failure of the joint.

To overcome this, a system of polypropylene injection on top of fusion bonded epoxy and adhesive has been developed which fully fuses the infill polypropylene to the parent coating thus eliminating any track for water to penetrate to the pipe surface. In addition, unlike polyurethanes, polypropylene is not subjected to hydrolysis. This normally affords total end to end integrity. This type of system is slow, in that it takes several hours for the infill to fully solidify. As a consequence, this type of system is not compatible with many offshore deep water pipe lay methods.

### SUMMARY OF THE INVENTION

Briefly, the present invention describes a method of improving the bond strength between a polyurethane joint infill material and the dissimilar polymer materials of the parent coating at a pipeline field joint in a wet insulation coating for a pipeline. The bonding is typically achieved by flame treatment or corona discharge of the surface of the parent coating at the field joint. With the present invention, heat to penetrate beneath the surface of the parent coating at the field joint is introduced. As a result, the bond strength is improved. The injected liquid polyurethane of the infill meets the heat treated parent coating surface and fully wets out the parent coating at the field joint out prior to the heated parent coating losing the added heat. In addition, the heat of reaction is not lost on a cold surface, causing better reaction on the surface. Steps are taken to confirm that the liquid polyurethane is injected within the gel time of the material and before the wet treated surface cools again to a satisfactory ambient temperature. Alternatively a strike coat of the liquid polyurethane can be applied while the surface maintains heat, and subsequent injection of polyurethane infill performed.

### BRIEF DESCRIPTION OF THE DRAWINGS

The single FIGURE in the drawings is an isometric view, taken partly in cross-section, of a pipeline field joint for wet insulation on a pipeline which is to be coated according to the present invention with improved bond strength between a polyurethane joint infill material and the polymer materials of a parent coating on the pipeline.

### DETAILED DESCRIPTION OF THE PREFERRED EMBODIMENTS

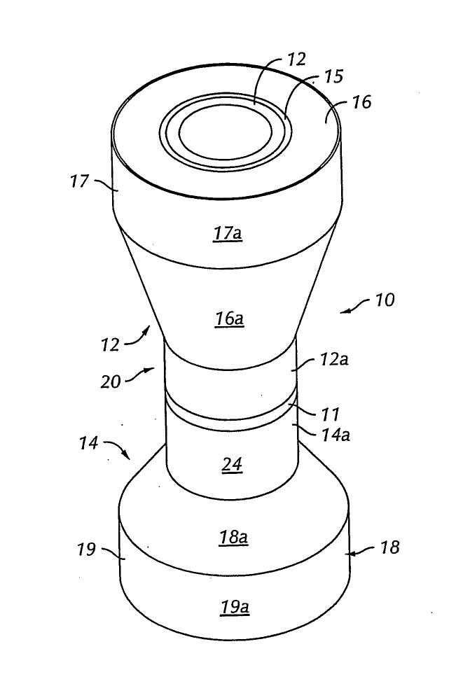

In the drawings, a pipeline 10 is shown (FIGURE 1) formed by welding two pipe sections 12 and 14 which are covered by a parent coating 16 and 18, respectively. As shown at 11, the pipe sections are joined together by welding. The pipeline 10 is typically one being laid in a relatively deep body of water and is thus shown extending generally in a vertical direction in which the pipeline 10 moves downwardly from a pipe laying barge, J-lay equipment or other suitable vessel into the body of water. It should be understood that the present invention may also be used in connection with S-lay pipeline methods or with reel lay installations, as well. Thus, the pipeline 10 may also extend generally horizontally during the pipe laying operation.

The parent coatings 16 and 18 associated with the pipe sections 12 and 14, respectively, are formed from a suitable thickness of insulated polymer, such as polypropylene. It should be understood, however, that other polymeric materials such as polyethylene or polyurethane may be used as parent coatings 16 and 18. The parent insulation coatings 16 and 18 cover the pipe sections 12 and 14 circumferentially and longitudinally except for a stub end portion of each pipe end 12a and 14a, respectively. The pipe ends or stubs 12a and 14a are exposed and extend from the parent coatings 16 and 18 to facilitate welding of the two pipe sections 12 and 14 together as sections of the pipeline 10. However, the exposed pipe stubs or ends are not coated with insulation and/or any corrosion coating in the pipeline 10.

A gap or joint 20 is thus present after joint welding at the location of the exposed pipe ends 12a and 14a. It is conventional practice to form a tapering chamfer area, such as at 16a and 18a at the end portions of the respective cuttings 16 and 18. This is done so that a greater surface area is present at the ends of the cuttings 16 and 18 for receiving a pipe joint infill coating. It is normally the case for deep water or wet insulated pipelines that the gap for joint 20 is filled with injected solid, water impermeable, polyurethane. The injected components react within the mold to form the desired wet insulation field joint infill.

An example of such an infill process is that set forth in applicant's co-pending U.S. Provisional Patent Application “PIPELINE FIELD JOINT COATING FOR WET INSULATION FIELD JOINTS”, Attorney Docket No. 085356.000041, filed of even date herewith, and claiming priority for U. S. Provisional Patent Application No. 60/848,467 filed Sep. 29, 2006. The subject matter of each of such applications is incorporated herein by reference for all purposes. A corrosion coating of any of several family available types is applied by conventional methods over the welded, exposed pipe ends 12a and 14a after welding and before application of the protective joint infill of the coating in the gap 20.

It has been conventional practice for the chamfer areas 16a and 18a and the corrosion coating to be surface heated, such as by flame heating or corona discharge. The flame or corona coating treatment alters the surface energy of the parent coating chamfer areas 16a and 18a of the polypropylene. The flame or corona treatment is intended to provide some bonding and also to allow a degree of cross-linking between the polypropylene and the polyurethane.

With the present invention, it has been found that the flame treatment can impart some heat, but that this heating is purely surface heating of the polypropylene parent coating in the chamfer areas 16a and 18a. Further, it has been found that if either of the chamfer areas of the 16a and 18a is over-treated by the surface heating process, this can cause waxing of the surface area. The result in such a case is to render the flame or corona coating treatment at least partially, if not completely, useless.

According to the present invention, a heating source is placed around each end of the field joint 20 and the chamfer areas 16a and 18a and the end portions of the parent coating 16 and 18. The end portions are then brought up to a desired bulk heat. Heat is preferably infrared heat applied by a bank of heaters. It should be understood that other types of heaters may be used. Heat in the desired temperature range is applied for an efficient dwell time. The dwell time depends upon the thickness and composition of the parent coatings 16 and 18, and the surface area extent of the chamfer areas 16a and 18a. The dwell time is of sufficient duration for the heat to be allowed to penetrate the coating beneath the chamfer area surfaces 16a and 18a, and the regions penetrated reach a temperature such that the applied joint infill polymer material may wet the parent coating surface during a gel time of the joint infill polymer.

Heating in this manner of the parent coating beneath the chamfer area surfaces 16a and 18a may take place either before or after the flame or corona coating treatment. As mentioned above, the surface treatment by flame or corona is applied to alter the surface energy of the polypropylene parent coating and allow a degree of cross-linking of the polypropylene and infill polyurethane. The chamfer areas 16a and 18a thus can be flame or corona treated, either before or after heating the surface beneath the chamfer surfaces 16a and 18a, and prior to the polyurethane pipe joint infill operation.

The present invention utilizes a suitable source of penetrating heat, such as infrared, but others could be used as well. With the present invention, soaking and or penetrating the surface with such heat, a reserve of heat is built up in the polypropylene. It has been found that the infill polyurethane thus takes a longer time to cool down to ambient temperature. As a result, more time is available for the wetting out process between the dissimilar polymer materials of the parent coating at the infill joint of the wet insulated pipeline to take place.

Thus, according to the present invention, a new and improved method for improving a bond is provided at a welded pipe joint connection between a polyurethane infill coating and end portions 12 and 14. The end portions are present on polymer insulated parent coatings 16 and 18 on a wet insulation pipeline 10 being laid beneath a body of water. The parent coatings beneath the surface at the chamfer areas 16a and 18a of the wet insulation coatings 16 and 18 are treated to a temperature so that the applied joint infill polymer material may wet the parent coating surfaces during the gel time of the joint infill polymer. The chamfer area surfaces 16a and 18a of the polymer parent coatings 16 and 18 adjacent the welded pipe joint connection are also heated, either by flame treatment, corona discharge or the like, so that the applied joint infill polymer material may bond and at least partially cross-link the two polymers. Heating the parent coating beneath the chamfer area surfaces 16a and 18a may take place either before or after the surface treating of such chamfer area surface. Thereafter, the polymer, typically polyurethane, pipe joint infill material may be applied to the welded pipe joint connection and the chamfer area polymer parent coating. The applied joint infill material is then allowed to bond to the chamfer area polymer parent coatings 16 and 18.

As this has been noted, the reserve of heat built up by heating the parent coating beneath the chamfer area surfaces 16a and 18a maintains the temperature in the parent coating for a longer time. Thus, when the polyurethane joint infill components are injected, the polyurethane takes a longer time to cool down. During the longer cool-down time the increased heat allows longer time for the wetting-out process between the dissimilar polymer materials of the parent coating at the infill joint. Thus, improved bond strength is achieved between the polyurethane joint infill material and the dissimilar polymer materials of the parent coating.

It should be understood that as an alternative, a strike coat of liquid polyurethane can be applied while the heated portions of the parent coating beneath the chamfer area surface maintains the heat applied thereto. Thereafter, injection of the polymer urethane infill can occur in the matter described above.

It should be noted and understood that there can be improvements and modifications invention described in detail above and set forth in an example claim in the following section which would be apparent or would be evident to those skilled in this art made of the present based on the teachings herein, and thus encompassed within the inventive concepts and suggestions contained and claimed herein, without departing from the spirit or scope of the present invention.

What is claimed is:

1. A method for improving the bond at a welded pipe joint connection between a polyurethane infill coating and end portions of a polymer insulation-coated parent coating on wet insulation pipeline being laid beneath a body of water, comprising the steps of:
heating a chamfer area surface of the polymer parent coating at a chamfer area adjacent the welded pipe joint connection so that an applied joint infill polymer material may bond and at least partially crosslink thereto;
heating the parent coating beneath the chamfer area surface to a temperature so that the applied joint infill polymer material may wet the parent coating surface during a gel time of the joint infill polymer;
applying the joint infill material to the welded pipe joint connection and the chamfer area polymer parent coating; and
allowing the applied joint infill material to bond to the chamfer area polymer parent coating.

2. The method of claim 1, wherein the step of heating the parent coating is performed before the step of heating a chamfer area surface.

3. The method of claim 1, wherein the step of heating the parent coating is performed after the step of heating a chamfer area surface.

4. The method of claim 1, wherein the step of heating comprises the step of:
flame treating the chamfer area surface.

5. The method of claim 1, wherein the step of heating comprises the step of:
heating by radiant heating the chamfer area surface.

6. The method of claim 5, wherein the step of heating the chamfer area surface further includes the step of:
corona heating the chamfer area surface subsequent to radiant heating thereof.

7. The method of claim 5, wherein the step of heating the chamfer area surface further includes the step of:
flame heating the chamfer area surface subsequent to radiant heating thereof.
